(19) United States
(12) Patent Application Publication
(10) Pub. No.: US 2002/0001054 A1
(43) Pub. Date: Jan. 3, 2002

(54) Color type liquid crystal display having a high aperture ratio

(76) Inventors: Byung Hyun Byun, Daejeon (KR); Jin Yong Seo, Kyoungki-do (KR)

Correspondence Address: Ladas & Parry, Suite 1200, 224 South Michigan Avenue, Chicago, IL, 60604, US

(21) Appl. No.: 09/894,231

(22) Filed: Jun. 28, 2001

(30) Foreign Application Priority Data
Jun. 29, 2000 (KR) 2000-36599

(51) Int. Cl. G02F 1/1335

(52) U.S. Cl. 349/106

(57) ABSTRACT

The present invention relates to a color type liquid crystal display having a high aperture ratio, comprising a first substrate which has black matrixes of a color filter arranged in a stripe and a second substrate which has black matrixes in a stripe perpendicular to the black matrixes of the color filter. The disclosed has a large alignment margin without deterioration when an upper and a lower substrates of color type STN are assembled each other, thereby increasing an aperture ratio and yield and decreasing power consumption.

### BACKGROUND OF THE INVENTION

Field of the Invention

The present invention relates to a color type liquid crystal display having a high aperture ratio, and more particularly to a color type liquid crystal display having a wide alignment margin when upper and lower substrates are assembled including a color type super twisted nematic (STN).

Generally, a liquid crystal display comprises upper and lower substrates, opposite to each other, a liquid crystal interposed between them and a polarizing plate disposed on the outer surface of substrates.

The upper substrate is referred to as a color filter substrate since a color filter is attached thereon to realize a color type liquid crystal display. The lower substrate is referred to as a TFT (thin film transistor) array substrate since pixel electrodes and thin film transistors are formed thereon in an active matrix type.

The color filter comprises red (R), green (G) and blue (B) color pixels and a black matrix around the color pixels. The black matrix corresponds to a gate bus line, a data bus line and a thin film transistor of TFT array substrate and color pixels correspond to pixel electrodes.

A conventional method of fabricating a liquid crystal display will be described in detail with reference to FIG. 1.

FIG. 1 is a layout for showing a color filter substrate of color TN/STN type LCD employing a conventional micro color filter.

Referring to FIG. 1, a color filter substrate of color TN/STN type LCD employing a conventional micro color filter 3 is fabricated by forming a black matrix 2 of lattice type and then forming red (R), green (G) and blue (B) color resists as shown in FIG. 1. Subsequently, an overcoat (not illustrated) is formed to have a cell gap uniformity and an ITO 4 is formed thereon and patterned, thereby completing the formation of color filter substrate.

The above color filter substrate is employed as a lower substrate, and then as shown in FIG. 2, an upper substrate is formed with a structure having ITO patterns 6 in a stripe type. The upper and lower substrates are combined by forming alignment layers thereon and then sealed by liquid crystals to complete a panel. A compensating film and a polarizing plate are attached to each side of the panel, thereby completing color TN/STN type LCD.

However, the conventional method has problems that it is difficult to obtain an alignment of 10 μm when the substrates are combined and an aperture ratio is decreased by enlarging the black matrix.

### SUMMARY OF THE INVENTION

The present invention has been made to solve the above-mentioned problems. The object of the present invention is to provide a color type liquid crystal display having a high aperture ratio and a large alignment margin when upper and lower substrates are assembled.

In order to achieve the above object, a color type liquid crystal display having a high aperture ratio of the present invention comprises a first substrate which has black matrixes of a color filter arranged in a stripe; and a second substrate which has black matrixes in a stripe perpendicular to the black matrixes of the color filter.

According to a preferred embodiment of the present invention, the color filter is employed in either upper or lower substrate.

According to another embodiment of the present invention, the black matrix of color filter is perpendicular to color pixels.

According to still another embodiment of the present invention, the black matrix of color filter is parallel to color pixels.

### BRIEF DESCRIPTION OF THE DRAWINGS

FIG. 1 is a layout for showing a color filter substrate of color TN/STN type LCD employing a conventional micro color filter.

FIG. 2 is a layout for showing an upper substrate for a color STN according to a conventional method.

FIG. 3 is a layout for showing a color filter substrate of color type liquid crystal display according to the present invention.

FIG. 4 is a layout for showing a panel of color type liquid crystal display according to the present invention.

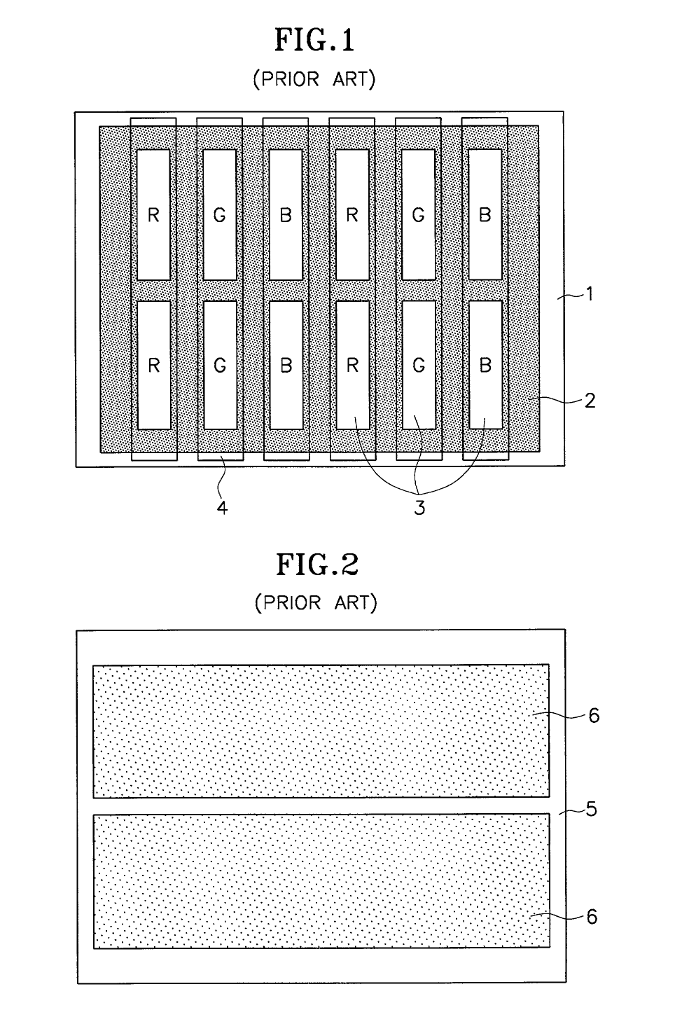

### DETAILED DESCRIPTION OF THE DRAWINGS

The above object, and other features and advantages of the present invention will become more apparent after reading the following detailed description when taken in conjunction with the drawings.

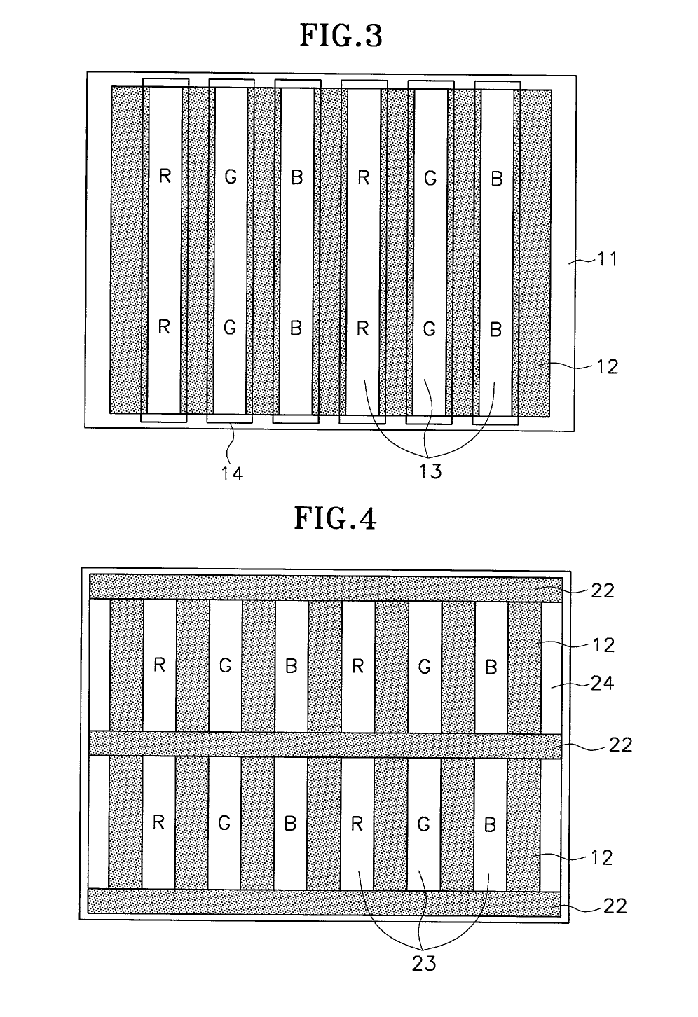

FIG. 3 is a layout for showing a color filter of color type liquid crystal display according to the present invention.

Referring to FIG. 3, black stripes 12 are formed in a stripe type on a lower glass substrate 11 and red (R), green (G) and blue (B) color resists 13 are formed in a stripe type being parallel with the black stripes 12. Thereafter, an overcoat (not illustrated) and an ITO 14 are deposited and selectively patterned and finally, an alignment layer is formed, thereby completing a lower substrate.

FIG. 4 is a layout for showing a panel of color type liquid crystal display according to the present invention.

Referring to FIG. 4, black stripes 22 are formed perpendicular to the black stripes 12 of the lower substrate. And then, an ITO 24 is deposited and selectively patterned and finally, an alignment layer is formed, thereby completing an upper substrate.

The resulting upper and lower substrates are combined and then, provided with liquid crystal therein and sealed, thereby completing a panel. Compensating films and polarizing plates are attached to both sides of the panel to form a color TN/STN.

As described above, according to the present invention, alignment margin and aperture ratio are increased, thereby reducing production cost.

The invention may be embodied in other specific forms without departing form the spirit or essential characteristics thereof. The present embodiment is therefore to be considered in all respects as illustrative and not restrictive. And all changes which come within the meaning and range of equivalency of the claims are therefore intended to be embraced therein.

What is claimed is:

1. A color type liquid crystal display comprising:
a first substrate which has black matrixes of a color filter arranged in a stripe; and
a second substrate which has black matrixes in a stripe perpendicular to the black matrixes of the color filter.

2. The color type liquid crystal display according to claim 1, wherein the color filter is employed in either an upper substrate or a lower substrate.

3. The color type liquid crystal display according to claim 1, wherein the color filter has black matrixes arranged perpendicular to each other.

4. The color type liquid crystal display according to claim 1, wherein the color filter has black matrixes in parallel to each other.

5. The color type liquid crystal display according to claim 1, wherein the color filter is a lower substrate and the second substrate is an upper substrate.
